(19) United States
(12) Patent Application Publication
(10) Pub. No.: US 2025/0211331 A1
(43) Pub. Date: Jun. 26, 2025

(54) MOBILE WIRELESS OPTICAL COMMUNICATION RECEIVER FOR MAXIMUM RATIO COUPLING TO DAYLIGHT NOISE AND METHOD ASSOCIATED THEREWITH

(71) Applicants: LG ELECTRONICS INC., Seoul (KR); KOREA ADVANCED INSTITUTE OF SCIENCE AND TECHNOLOGY, Daejeon (KR)

(72) Inventors: Hojae LEE, Seoul (KR); Hoon KIM, Seoul (KR); Gihong PARK, Seoul (KR); Sangrim LEE, Seoul (KR); Thi Mat NGUYEN, Seoul (KR)

(73) Assignees: LG ELECTRONICS INC., Seoul (KR); KOREA ADVANCED INSTITUTE OF SCIENCE AND TECHNOLOGY, Daejeon (KR)

(21) Appl. No.: 18/846,206

(22) PCT Filed: Mar. 31, 2022
(86) PCT No.: PCT/KR2022/004586

§ 371 Date: Sep. 11, 2024

(51) Int. Cl. H04B 10/11

(52) U.S. Cl. CPC H04B 10/11

(57) ABSTRACT

Provided are a method and a device used in an optical wireless communication (OWC) system. A receiver comprises an optical amplifier and detector that receives an optical signal including a target signal and/or daylight noise as an input to output baseband electrical signals for digital signal processing. The optical amplifier and detector comprises: (1) an optical amplifier that amplifies the optical signal; (2) an optical diplexer that filters the amplified optical signal into an in-band wavelength band and an out-of-band wavelength band, respectively; (3) an optical attenuator that receives the target signal present in the in-band wavelength band as an input and outputs an attenuated target signal; (4) a first photodetector that converts the attenuated target signal into a first baseband electrical signal; (5) an electric filter; and (6) a second photodetector that converts the daylight noise into a second baseband electrical signal.

### CROSS-REFERENCE TO RELATED APPLICATION(S)

This application is the National Stage filing under 35 U.S.C. 371 of International Application No. PCT/KR2022/004586, filed on Mar. 31, 2022, the contents of which are all incorporated by reference herein in its entirety.

### TECHNICAL FIELD

The present disclosure relates to a method and apparatus for use in an Optical Wireless Communication (OWC) system.

### BACKGROUND

3rd Generation Partnership Project (3GPP) Long-Term Evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in International Telecommunication Union (ITU) and 3GPP to develop requirements and specifications for New Radio (NR) systems. 3GPP has to identify and develop the technology components needed for successfully standardizing the new RAT timely satisfying both the urgent market needs, and the more long-term requirements set forth by the ITU Radio communication sector (ITU-R) International Mobile Telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced Mobile BroadBand (eMBB), massive Machine Type Communications (mMTC), Ultra-Reliable and Low Latency Communications (URLLC), etc. The NR shall be inherently forward compatible.

With the commercialization of New Radio (NR), the fifth generation (5G) mobile communications technology, research into sixth generation (6G) mobile communications technology is beginning. It is expected that 6th generation mobile communication technology will utilize frequency bands above 100 GHz. This is expected to increase the number of utilized frequencies by more than 10 times compared to 5G, and allow for greater utilization of spatial resources.

Electromagnetic waves in the radio frequency band have been widely used as a resource for wireless communication technology. To date, the vast amounts of wireless communication traffic required by advancing communication generations have been handled by increasing the available radio frequency bands or reducing the size of the cells covered by base stations. However, the development of wireless communication technology in the radio frequency band is becoming increasingly challenging due to the limitations of electronic devices as the frequency increases to tens of GHz and beyond, and the need for advanced beamforming technology due to the increasing straightness of the carrier.

### SUMMARY

Optical Wireless Communication (OWC) is a good alternative for organizing future mobile communication systems. OWC has the advantage of using ultra-wideband optical frequency resources, which are free from frequency allocation regulations, and of using fiber-based ultra-high speed communication system technologies that are already quite mature. The beamforming technology that is currently being actively researched and developed is also expected to be easy to apply, as it is not fundamentally different from the beam alignment technology used in mobile wireless optical communication systems.

However, OWC-based wireless communications can be exposed to solar noise. In particular, solar noise in the optical frequency band has a very high-power value, which can cause the failure of the optical receiver, which in turn can cause a sharp decrease in the reception sensitivity of the communication system, resulting in communication paralysis. Therefore, solar noise needs to be considered when designing a mobile wireless optical communication system.

In addition, in conventional wireless optical communication systems that use only Line-of-Sight (LoS), frequent link losses can occur due to the mobility of the transmitter and receiver and obstacles between the transmitter and receiver ends. Since 6G wireless communication systems will require hyper-connectivity, this also needs to be considered when designing a mobile wireless optical communication system.

As a result, it is necessary to design a receiving system for OWC that can effectively deal with solar noise.

In an aspect, a receiver operating in an Optical Wireless Communication (OWC) system is provided. The receiver comprises, an optical amplifier and detector that takes as input an optical signal comprising a target signal and/or solar noise and outputs baseband electrical signals for a digital signal processing process. The optical amplifier and detector comprises: 1) an optical amplifier that amplifies the optical signal to output an amplified optical signal, 2) an optical diplexer for filtering and outputting the amplified optical signal into an in-band wavelength band and an out-of-band wavelength band, respectively, 3) an optical attenuator that takes as input the target signal present in the in-band wavelength band and outputs an attenuated target signal with reduced power, 4) a first photodetector for converting the attenuated target signal into a first baseband electrical signal of the baseband electrical signals, 5) an electrical filter for low-pass filtering the first baseband electrical signal, and 6) a second photodetector for converting the solar noise present in the out-of-band wavelength band into a second baseband electrical signal of the baseband electrical signals.

In another aspect, a receiver operating in an Optical Wireless Communication (OWC) system is provided. The receiver comprises, a plurality of photoelectric amplification receivers each taking an optical signal as an input and outputting a first baseband electrical signal based on a target signal and a second baseband electrical signal based on solar noise, an analog-to-digital converter for sampling the first baseband electrical signal and the second baseband electrical signal, and a digital signal processor for calculating a maximum ratio combining algorithm based on the first baseband electrical signal the second baseband electrical signal which are sampled, and demodulating the same to output final received data.

In another aspect, a method performed by the receiver operating in the OWC system is provided.

The present disclosure can have various advantageous effects.

For example, based on a mobile OWC receiver comprising a plurality of Optical Frequency (OF) chains, reception diversity over a LOS/NLOS path can be obtained.

For example, in an environment where daylight interference may increase as reception diversity increases, daylight effects can be detected and maximum ratio combining diversity gain can be adaptively obtained.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows an example of a communication system to which implementations of the present disclosure are applied.

FIG. 2 shows an example of wireless devices to which implementations of the present disclosure are applied.

FIG. 3 shows an example of a wireless device to which implementations of the present disclosure are applied.

FIG. 4 shows an example of UE to which implementations of the present disclosure are applied.

FIG. 5 shows an example of an electromagnetic wave spectrum.

FIG. 6 shows an example of a method of generating a THz signal based on an optical device.

FIG. 7 shows an example of a transceiver for THz wireless communications based on an optical device.

FIG. 8 shows an example of a structure of a transmitter based on a photonic source.

FIG. 9 shows an example of a structure of an optical modulator.

FIG. 10 shows an example of a structure of a single photoelectric amplification receiver according to the first implementation of the present disclosure.

FIG. 11 shows an example of an input (A) of a single photoelectric amplification receiver and an input (C) of an optical amplification and detection device according to the first implementation of the present disclosure.

FIG. 12 shows an example of a structure of an optical amplifier and detector constituting a single photoelectric amplification receiver according to the first implementation of the present disclosure.

FIG. 13 shows an example of power distribution of components of an optical amplifier and detector output noise (N_{(G1)}) with and without solar noise, according to the first implementation of the present disclosure.

FIG. 14 shows an example of irradiance spectrum of sunlight.

FIG. 15 shows an example of PSD of noise at the output of an electrical filter of a single photoelectric amplification receiver in the 1550 nm wavelength band as a function of the direct solar irradiance and indirect solar irradiance incident on the receiver.

FIG. 16 shows an example of relationship of output power P_{(F)} as a function of input power P_{(C)} of an optical signal input to an optical amplifier.

FIG. 17 shows an example in which an input optical signal is filtered by an optical diplexer according to the first implementation of the present disclosure.

FIG. 18 shows an example of a method performed by a receiver operating in an OWC system according to the first implementation of the present disclosure.

FIG. 19 shows an example of a structure of a multiple aperture-based mobile OWC receiver according to the second implementation of the present disclosure.

FIG. 20 shows an example of a structure of a digital signal processor included in a multiple aperture-based mobile OWC receiver according to the second implementation of the present disclosure.

FIG. 21 shows an example of a method performed by a receiver operating in an OWC system according to the second implementation of the present disclosure.

### DETAILED DESCRIPTION

The following techniques, apparatuses, and systems may be applied to a variety of wireless multiple access systems. Examples of the multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a Multi Carrier Frequency Division Multiple Access (MC-FDMA) system. CDMA may be embodied through radio technology such as Universal Terrestrial Radio Access (UTRA) or CDMA2000. TDMA may be embodied through radio technology such as Global System for Mobile communications (GSM), General Packet Radio Service (GPRS), or Enhanced Data rates for GSM Evolution (EDGE). OFDMA may be embodied through radio technology such as Institute of Electrical and Electronics Engineers (IEEE) 802.11 (Wi-Fi), IEEE 802.16 (WiMAX), IEEE 802.20, or Evolved UTRA (E-UTRA). UTRA is a part of a Universal Mobile Telecommunications System (UMTS). 3rd Generation Partnership Project (3GPP) Long-Term Evolution (LTE) is a part of Evolved UMTS (E-UMTS) using E-UTRA. 3GPP LTE employs OFDMA in downlink (DL) and SC-FDMA in uplink (UL). Evolution of 3GPP LTE includes LTE-Advanced (LTE-A), LTE-A Pro, and/or 5G New Radio (NR).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

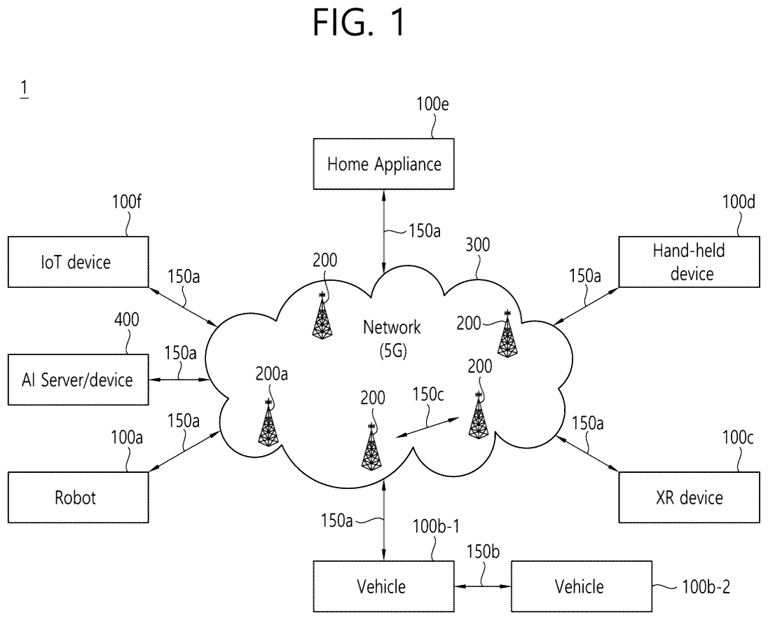

FIG. 1 shows an example of a communication system to which implementations of the present disclosure are applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced Mobile BroadBand (eMBB), (2) a category of massive Machine Type Communication (mMTC), and (3) a category of Ultra-Reliable and Low Latency Communications (URLLC).

Referring to FIG. 1, the communication system 1 includes wireless devices 100a to 100f, Base Stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using Radio Access Technology (RAT) (e.g., 5G NR or LTE) and may be referred to as communication/radio/5G devices. The wireless devices 100a to 100f may include, without being limited to, a robot 100a, vehicles 100b-1 and 100b-2, an extended Reality (XR) device 100c, a hand-held device 100d, a home appliance 100e, an Internet-of-Things (IoT) device 100f, and an Artificial Intelligence (AI) device/server 400. For example, the vehicles may include a vehicle having a wireless communication function, an autonomous driving vehicle, and a vehicle capable of performing communication between vehicles. The vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called User Equipments (UEs). A UE may include, for example, a cellular phone, a smartphone, a laptop computer, a digital broadcast terminal, a Personal Digital Assistant (PDA), a Portable Multimedia Player (PMP), a navigation system, a slate Personal Computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The UAV may be, for example, an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a Closed-Circuit TV (CCTV), a recorder, or a black box.

The FinTech device may be, for example, a device capable of providing a financial service such as mobile payment. For example, the FinTech device may include a payment device or a Point of Sales (POS) system.

The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or Device-to-Device (D2D) communication) 150b, inter-base station communication 150c (e.g., relay, Integrated Access and Backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

AI refers to the field of studying artificial intelligence or the methodology that can create it, and machine learning refers to the field of defining various problems addressed in the field of AI and the field of methodology to solve them. Machine learning is also defined as an algorithm that increases the performance of a task through steady experience on a task.

Robot means a machine that automatically processes or operates a given task by its own ability. In particular, robots with the ability to recognize the environment and make self-determination to perform actions can be called intelligent robots. Robots can be classified as industrial, medical, home, military, etc., depending on the purpose or area of use. The robot can perform a variety of physical operations, such as moving the robot joints with actuators or motors. The movable robot also includes wheels, brakes, propellers, etc., on the drive, allowing it to drive on the ground or fly in the air.

Autonomous driving means a technology that drives on its own, and autonomous vehicles mean vehicles that drive without user's control or with minimal user's control. For example, autonomous driving may include maintaining lanes in motion, automatically adjusting speed such as adaptive cruise control, automatic driving along a set route, and automatically setting a route when a destination is set. The vehicle covers vehicles equipped with internal combustion engines, hybrid vehicles equipped with internal combustion engines and electric motors, and electric vehicles equipped with electric motors, and may include trains, motorcycles, etc., as well as cars. Autonomous vehicles can be seen as robots with autonomous driving functions.

Extended reality is collectively referred to as VR, AR, and MR. VR technology provides objects and backgrounds of real world only through Computer Graphic (CG) images. AR technology provides a virtual CG image on top of a real object image. MR technology is a CG technology that combines and combines virtual objects into the real world. MR technology is similar to AR technology in that they show real and virtual objects together. However, there is a difference in that in AR technology, virtual objects are used as complementary forms to real objects, while in MR technology, virtual objects and real objects are used as equal personalities.

NR supports multiples numerologies (and/or multiple Sub-Carrier Spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., Frequency Range 1 (FR1) and Frequency Range 2 (FR2). The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHZ range,” and may be referred to as millimeter Wave (mmW).

TABLE 1

| Frequency Range | Corresponding | |
|---|---|---|
| designation | frequency range | Subcarrier Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHZ, etc.) or more included in FR1 may include an unlicensed band. Unlicensed bands may be used for a variety of purposes, for example for communication for vehicles (e.g., autonomous driving).

TABLE 2

| Frequency Range | Corresponding | |
|---|---|---|
| designation | frequency range | Subcarrier Spacing |
| FR1 | 410 MHz-7125 MHz | 15, 30, 60 kHz |
| FR2 | 24250 MHz-52600 MHz | 60, 120, 240 kHz |

Here, the radio communication technologies implemented in the wireless devices in the present disclosure may include NarrowBand IoT (NB-IoT) technology for low-power communication as well as LTE, NR and 6G. For example, NB-IoT technology may be an example of Low Power Wide Area Network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced MTC (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate Personal Area Networks (PANs) associated with small/low-power digital communication based on various specifications such as IEEE 802.15.4 and may be called various names.

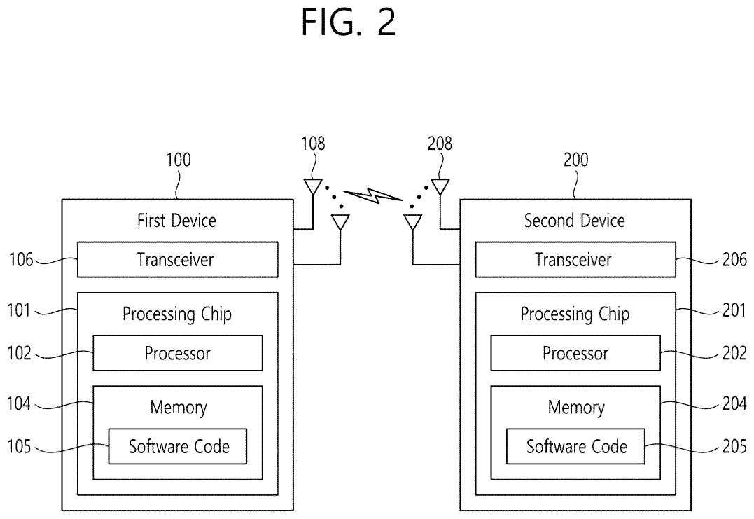

FIG. 2 shows an example of wireless devices to which implementations of the present disclosure are applied.

Referring to FIG. 2, a first wireless device 100 and a second wireless device 200 may transmit/receive radio signals to/from an external device through a variety of RATs (e.g., LTE and NR).

In FIG. 2, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. It is exemplarily shown in FIG. 2 that the memory 104 is included in the processing chip 101. Additional and/or alternatively, the memory 104 may be placed outside of the processing chip 101.

The processor 102 may control the memory 104 and/or the transceiver 106 and may be configured to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a software code 105 which implements instructions that, when executed by the processor 102, perform the descriptions, functions, procedures, suggestions, methods and/or operational flowcharts disclosed in the present disclosure. For example, the software code 105 may implement instructions that, when executed by the processor 102, perform the descriptions, functions, procedures, suggestions, methods and/or operational flowcharts disclosed in the present disclosure. For example, the software code 105 may control the processor 102 to perform one or more protocols. For example, the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with Radio Frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. It is exemplarily shown in FIG. 2 that the memory 204 is included in the processing chip 201. Additional and/or alternatively, the memory 204 may be placed outside of the processing chip 201.

The processor 202 may control the memory 204 and/or the transceiver 206 and may be configured to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, when executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as physical (PHY) layer, Media Access Control (MAC) layer, Radio Link Control (RLC) layer, Packet Data Convergence Protocol (PDCP) layer, Radio Resource Control (RRC) layer, and Service Data Adaptation Protocol (SDAP) layer). The one or more processors 102 and 202 may generate one or more Protocol Data Units (PDUs) and/or one or more Service Data Units (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, suggestions, methods and/or operational flowcharts disclosed in the present disclosure may be implemented using firmware or software and the firmware or software may be configured to include the modules, procedures, or functions. Firmware or software configured to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures, suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable ROMs (EEPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

In the implementations of the present disclosure, a UE may operate as a transmitting device in UL and as a receiving device in DL. In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be configured to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be configured to perform the BS behavior according to an implementation of the present disclosure or control the transceiver(s) 206 to perform the BS behavior according to an implementation of the present disclosure.

In the present disclosure, a BS is also referred to as a Node B (NB), an eNode B (eNB), or a gNB.

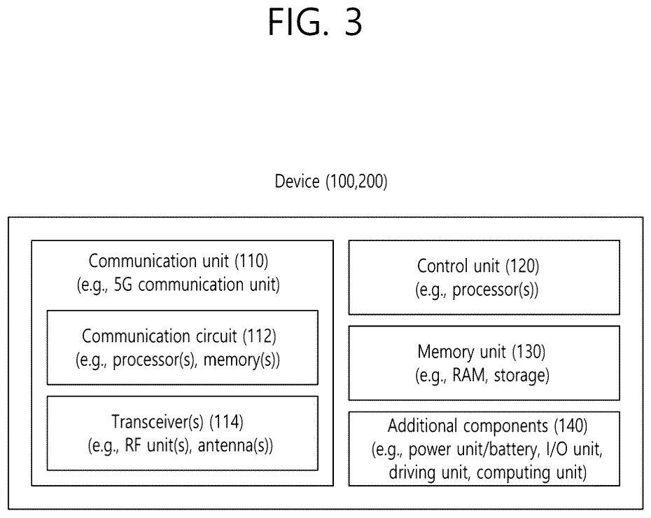

FIG. 3 shows an example of a wireless device to which implementations of the present disclosure are applied.

The wireless device may be implemented in various forms according to a use-case/service (refer to FIG. 1).

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 of FIG. 2 and/or the one or more memories 104 and 204 of FIG. 2. For example, the transceiver(s) 114 may include the one or more transceivers 106 and 206 of FIG. 2 and/or the one or more antennas 108 and 208 of FIG. 2. The control unit 120 is electrically connected to the communication unit 110, the memory unit 130, and the additional components 140 and controls overall operation of each of the wireless devices 100 and 200. For example, the control unit 120 may control an electric/mechanical operation of each of the wireless devices 100 and 200 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the wireless devices 100 and 200. For example, the additional components 140 may include at least one of a power unit/battery, Input/Output (I/O) unit (e.g., audio I/O port, video I/O port), a driving unit, and a computing unit. The wireless devices 100 and 200 may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc. The wireless devices 100 and 200 may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an Application Processor (AP), an Electronic Control Unit (ECU), a Central Processing Unit (CPU), a Graphical Processing Unit (GPU), and a memory control processor. As another example, the memory unit 130 may be configured by a RAM, a Dynamic RAM (DRAM), a ROM, a flash memory, a volatile memory, a non-volatile memory, and/or a combination thereof.

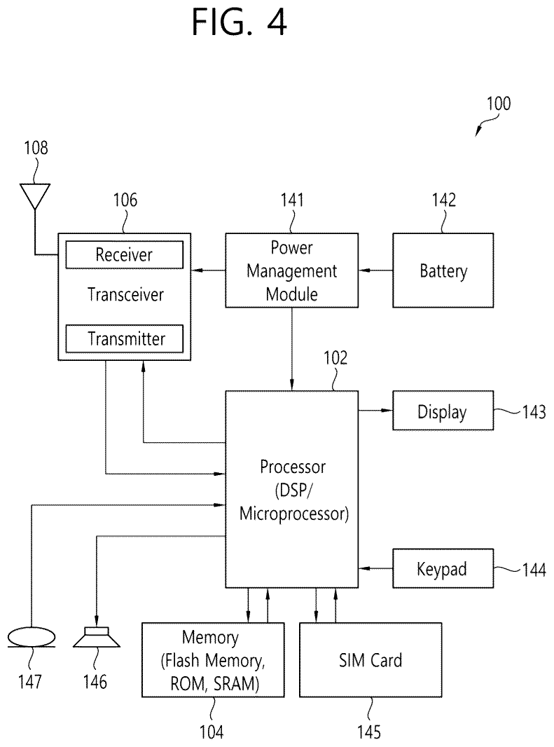

FIG. 4 shows an example of UE to which implementations of the present disclosure are applied.

Referring to FIG. 4, a UE 100 may correspond to the first wireless device 100 of FIG. 2 and/or the wireless device 100 or 200 of FIG. 3.

A UE 100 includes a processor 102, a memory 104, a transceiver 106, one or more antennas 108, a power management module 141, a battery 142, a display 143, a keypad 144, a Subscriber Identification Module (SIM) card 145, a speaker 146, and a microphone 147.

The processor 102 may be configured to implement the descriptions, functions, procedures, suggestions, methods and/or operational flowcharts disclosed in the present disclosure. The processor 102 may be configured to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of DSP, CPU, GPU, a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 141 manages power for the processor 102 and/or the transceiver 106. The battery 142 supplies power to the power management module 141.

The display 143 outputs results processed by the processor 102. The keypad 144 receives inputs to be used by the processor 102. The keypad 144 may be shown on the display 143.

The SIM card 145 is an integrated circuit that is intended to securely store the International Mobile Subscriber Identity (IMSI) number and its related key, which are used to identify and authenticate subscribers on mobile telephony devices (such as mobile phones and computers). It is also possible to store contact information on many SIM cards.

The speaker 146 outputs sound-related results processed by the processor 102. The microphone 147 receives sound-related inputs to be used by the processor 102.

The 6G wireless communication system (hereinafter referred to simply as 6G) is described.

6G is intended to enable (i) very high data rates per device, (ii) a very large number of connected devices, (iii) global connectivity, (iv) very low latency, (v) reduced energy consumption for battery-free IoT devices, (vi) ultra-reliable connectivity, and (vii) connected intelligence with machine learning capabilities. 6G may include four aspects: intelligent connectivity, deep connectivity, holographic connectivity, and ubiquitous connectivity. In addition to 5G's main categories of eMBB, URLLC, and mMTC, 6G may also include AI integrated communication, tactile internet, high throughput, high network capacity, high energy efficiency, low backhaul and access network congestion, and enhanced data security as key factors.

Table 3 shows an example of the requirements for 6G.

TABLE 3

| | | |
|---|---|---|
| Per device peak data rate | 1 | Tbps |
| E2E latency | 1 | ms |
| Maximum spectral | 100 | bps/Hz |

| | |
|---|---|
| efficiency | |
| Mobility support | Up to 1000 km/hr |
| Satellite integration | Fully |
| AI | Fully |
| Autonomous vehicle | Fully |
| XR | Fully |
| Haptic Communication | Fully |

Referring to Table 3, 6G is expected to have 50 times more concurrent wireless connectivity than 5G. In addition, URLLC, a key feature of 5G, is expected to become a more dominant technology in 6G by providing End-to-End (E2E) latency of less than 1 ms. 6G is expected to have much better volumetric spectral efficiency, as opposed to the more commonly used area spectral efficiency. 6G is expected to offer very long battery life and advanced battery technologies for energy harvesting, so mobile devices operating on 6G will not need to be charged separately.

The new network characteristics of 6G may include the following.
Satellites integrated network: To provide global mobile aggregation, 6G networks are expected to be integrated with satellites. The integration of terrestrial, satellite, and airborne networks into one wireless communication system is critical to 6G.
Connected intelligence: Unlike previous generations of wireless communication systems, 6G networks will be more innovative and are expected to update the wireless evolution from “connected things” to “connected intelligence”. AI can be applied to every procedure and/or step of communication.
Seamless integration wireless information and energy transfer: 6G networks are expected to carry power to charge the batteries of devices such as smartphones and sensors. Therefore, the transmission of wireless information and energy transfer can be integrated.
Ubiquitous super 3D connectivity: Ubiquitous super 3D connectivity can be achieved in 6G through access to networks and core network functions from drones and very low Earth orbit satellites.

General requirements for the new network characteristics of 6G described above may include the following.
Small cell networks: The idea of small cell networks was introduced in cellular systems to improve the quality of the received signal through improvements in throughput, energy efficiency, and spectral efficiency. Small cell networks are an essential characteristic for 5G and post-5G communication systems. Therefore, 6G networks can also adopt the characteristics of small cell networks.
Ultra-dense heterogeneous network: 6G networks can introduce ultra-dense heterogeneous networks. A multi-tiered network composed of heterogeneous networks can improve overall Quality of Service (QOS) and reduce costs.
High-capacity backhaul: 6G networks can introduce high-capacity backhaul networks to support high volumes of traffic. High-speed optical fiber and Free Space Optics (FSO) systems may be introduced for high-capacity backhaul networks.
Radar technology integrated with mobile technology: High-precision localization (or location-based services) over communications is one of the key features of 6G. Therefore, 6G networks can be integrated with radar systems.
Softwarization and virtualization: Softwarization and virtualization are two important features that are fundamental to the design process in 5G and beyond networks to ensure flexibility, reconfigurability, and programmability. As a result, 6G networks can adopt softwarization and virtualization. Softwarization and virtualization will allow billions of devices to be shared on a shared physical infrastructure.

As part of the core technologies for 6G, Terahertz (THz) wireless communication and Optical Wireless Communication (OWC) are described.

THz wireless communication is the use of THz waves, which have a frequency of approximately 0.1 to 10 THz, to perform wireless communication. In other words, THz wireless communication uses very high carrier frequencies in the 100 GHz and above band to perform wireless communication. THz waves are located between the Radio Frequency (RF)/millimeter ave (mmWave) and infrared bands. Compared to visible/infrared light, THz waves penetrate non-metallic/non-polarized materials well, and due to their shorter wavelength compared to RF/millimeter waves, they have high straightness and can be beam focused. In addition, the photon energy of THz waves is only a few meV, making them harmless to the human body. The frequency bands expected to be utilized for THz wireless communications can be in the D-band (110 GHz to 170 GHz) or H-band (220 GHz to 325 GHz) bands, where propagation losses due to absorption by molecules in the air are small. THz wireless communications can have applications in wireless cognition, sensing, imaging, wireless communication, and THz navigation. Standardization discussions for THz wireless communications are underway in the 3GPP and IEEE 802.15 THz working group.

In addition, OWC is already in use since 4G, but is expected to be more widely used to meet the requirements of 6G. In addition to RF-based communications for all device-to-device networks possible in 6G, OWC can be applied to network-to-backhaul/fronthaul network connections. OWC-related technologies such as light fidelity, visible light communication, optical camera communication, and FSO communication based on optical bands are already well known. OWC-based communication can provide very high data rates, low latency, and secure communication. In addition, in 6G, Light Detection And Ranging (LiDAR) can be utilized for ultra-high resolution 3D mapping based on the optical band.

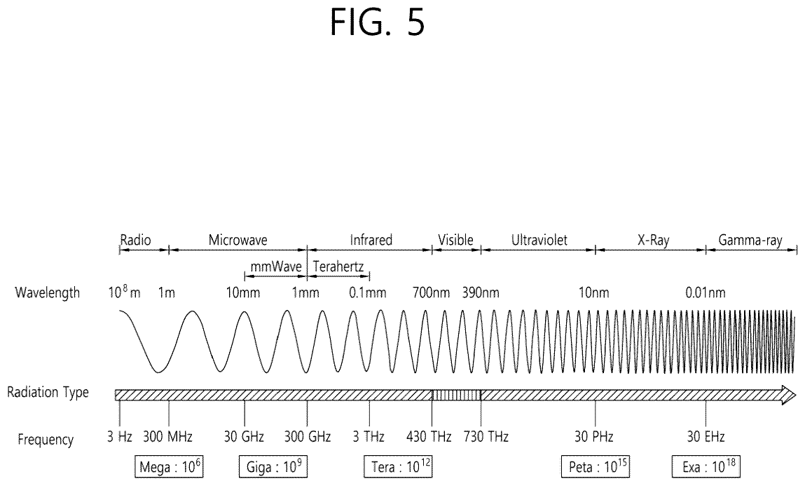

FIG. 5 shows an example of an electromagnetic wave spectrum.

The data rate can be increased by increasing the bandwidth. For example, the data rate can be increased by using the wide bandwidth of the sub-terahertz (sub-THz) band and applying advanced massive Multiple-Input and Multiple-Output (MIMO) techniques.

The THz band refers to the frequency band between 0.1 THz (i.e., 100 GHz) and 10 THz with wavelengths typically ranging from 0.03 mm to 3 mm. The 100 GHz-300 GHz portion of the THz band can be referred to as the sub-THz band and can be considered the main portion of the THz band for cellular communications. By using the sub-THz band in addition to the mmWave band, the communication capacity of 6G can be increased. In addition, the 300 GHz-3 THz portion of the THz band is in the Far Infrared (FIR) band. The 300 GHz-3 THz band is part of the optical band, but it is on the border of the optical band, just behind the RF band. As such, the 300 GHz-3 THz band can have RF-like characteristics.

The key characteristics of THz communications include (i) widely available bandwidth to support very high data rates, and (ii) high path losses that occur at high frequencies (hence, highly directional antennas are essential). The narrow beamwidth produced by highly directive antennas can reduce interference. To support the small wavelength of THz signals, a much larger number of antenna elements can be integrated into devices and base stations operating in this band than is currently possible. This will allow advanced adaptive array techniques to be used to overcome range limitations.

Scenarios for THz wireless communications can include macro networks, micro networks, and nanoscale networks. In macro networks, THz wireless communications can be applied to Vehicle-to-Vehicle (V2V) connections and backhaul/fronthaul connections. In micro networks, THz wireless communications can be applied to fixed point-to-point or multi-point connections such as indoor small cells, wireless connections within data centers, and near-field communications such as kiosk downloads.

Table 4 shows an example of technologies that can be utilized in THz waves.

TABLE 4

| | |
|---|---|
| Transceivers | UTC-PD, RTD and SBD |
| Device | |
| Modulation and | Low order modulation techniques (OOK, QPSK), |
| coding | LDPC, Reed Soloman, Hamming, Polar, Turbo |
| Antenna | Omni and Directional, phased array with low number |
| | of antenna elements |
| Bandwidth | 69 GHz (or 23 GHz) at 300 GHz |
| Channel models | Partially |
| Data rate | 100 Gbps |
| Outdoor | No |
| deployment | |
| Free space loss | High |
| Coverage | Low |
| Radio | 300 GHz indoor |
| Measurements | |
| Device size | Few micrometers |

THz wireless communications can be categorized into electronic device-based and optical device-based according to the method for generating/producing and receiving THz signals.

### (1) Electronic Device-Based

Electronic device-based methods for generating/producing THz signals include a method utilizing semiconductor devices such as Resonant Tunneling Diode (RTD), a method utilizing a local oscillator and multiplier, a Monolithic Microwave Integrated Circuit (MMIC) method utilizing compound semiconductor High Electron Mobility Transistors (HEMT)-based integrated circuits, a method utilizing Si-Complementary Metal-Oxide-Semiconductor (Si-CMOS)-based integrated circuits.

For example, in a method of generating/producing THz signals using a local oscillator and multiplier, the multiplier (e.g., doubler, tripler, etc.) may be applied to increase the frequency. The multiplier is a circuit that has an output frequency N times that of the input, and is responsible for matching the THz signals to the desired harmonic frequency, while filtering out all other frequencies. The multiplier is essential for the higher frequencies in the THz band. After the subharmonic mixer, the THz signals may be radiated by antennas. In addition, beamforming may be realized by applying array antennas or the like to the antennas.

### (2) Optical Device-Based

THz wireless communication based on optical devices refers to a method of generating and modulating THz signals using optical devices. The method of generating/producing THz signals based on optical devices generates ultra-high-speed optical signals using lasers and optical modulators, and converts them into THz signals using ultra-high-speed photodetectors. Compared to THz wireless communication technologies based on electronic devices, THz wireless communication technologies based on optical devices may easily increase the frequency, generate high power signals, and obtain flat response characteristics over a wide frequency band.

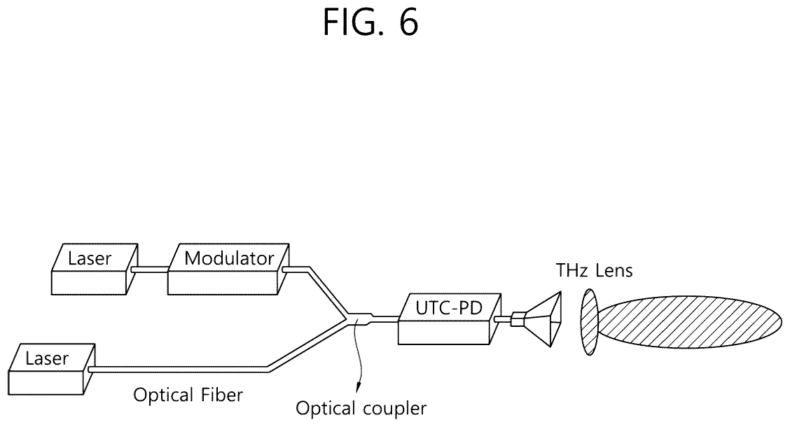

FIG. 6 shows an example of a method of generating a THz signal based on an optical device.

Referring to FIG. 6, a laser diode, an optical modulator, an optical coupler, and an ultrafast photodetector may be required to generate an optical device-based THz signal. In FIG. 6, light signals from two lasers with different wavelengths may be combined to generate a THz signal corresponding to the wavelength difference between the lasers. The optical coupler is a semiconductor device that allows electrical signals to be transmitted using light waves to provide coupling with electrical isolation between circuits or systems. A Uni-Travelling Carrier Photo-Detector (UTC-PD) is a type of photodetector, a device that uses electrons as the active carrier and reduces the electron's travel time by bandgap grading. UTC-PDs are capable of photodetection at 150 GHz and above.

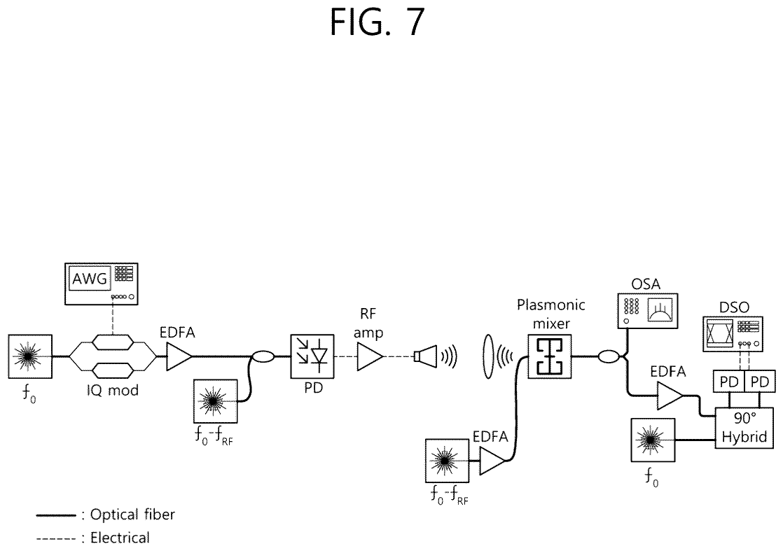

FIG. 7 shows an example of a transceiver for THz wireless communications based on an optical device.

In FIG. 7, Erbium-Doped Fiber Amplifier (EDFA) denotes an erbium-doped fiber amplifier. A Photo Detector (PD) represents a semiconductor device that converts an optical signal into an electrical signal. An Optical Sub-Assembly (OSA) refers to an optical module that modularizes various optical communication functions (e.g., photo-electric conversion, electric-photo conversion, etc.) into a single component. A Digital Storage Oscilloscope (DSO) represents a digital storage oscilloscope.

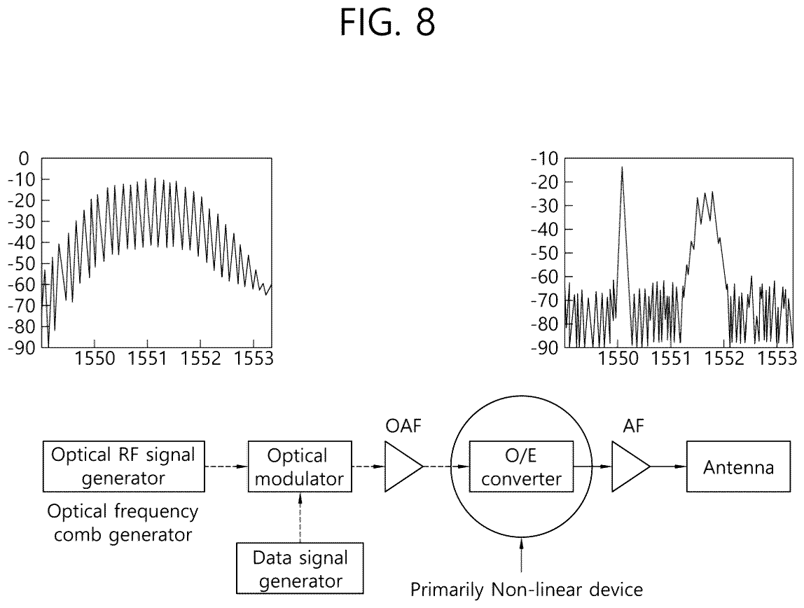

FIG. 8 shows an example of a structure of a transmitter based on a photonic source.

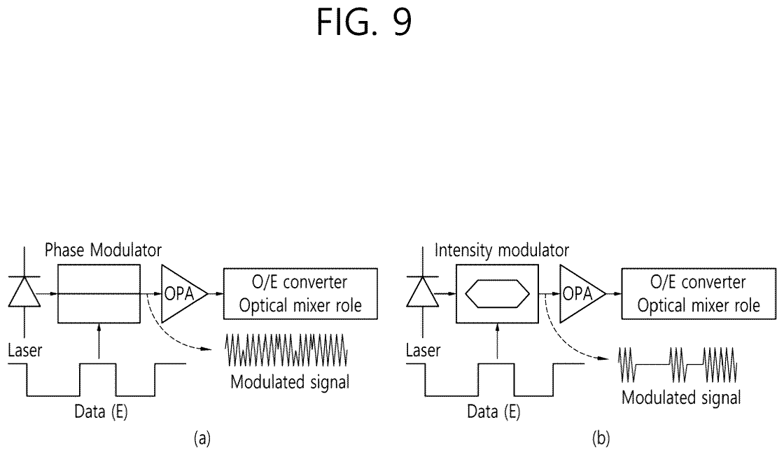

FIG. 9 shows an example of a structure of an optical modulator.

Referring to FIGS. 8 and 9, the structure of an Optical/Electrical (O/E) converter may be described. In general, an optical source of a laser may be passed through an optical wave guide to change the phase of a signal. In this case, data may be loaded by changing the electrical characteristics through a microwave contact or the like. Thus, the optical modulator output may be formed in a modulated form of a waveform. The photoelectric converter may generate THz pulses by optical rectification by a nonlinear crystal, photoelectric conversion by a photoconductive antenna, emission from a bunch of relativistic electrons at the speed of light, etc. A THz pulse generated in any of the above ways may have a length in the femto-second to pico-second range. The photoelectric converter may utilize the non-linearity of the device to perform a down-conversion.

Considering the uses of the THz band, it is likely that several contiguous GHz bands will be used for THz wireless communications, either for fixed or mobile services. Based on outdoor scenarios, the available bandwidth may be categorized based on an oxygen attenuation of 102 dB/km in bands up to 1 THz. Accordingly, a framework in which the available bandwidth is organized into multiple band chunks may be considered. As an example of such framework, if the length of a THz pulse is set to 50 ps for one carrier, the bandwidth may be about 20 GHz.

Effective down-conversion from the infrared band to the THz band depends on how the non-linearity of the photoelectric converter is utilized. That is, in order to down-convert to the desired THz band, it may be necessary to design a photoelectric converter with the most ideal non-linearity for conversion to that THz band. If a photoelectric converter that is not matched to the target frequency band is used, it is likely that errors in the magnitude and phase of the THz pulse may occur.

In a single-carrier system, a THz wireless communication system may be implemented using a single photoelectric converter. Depending on the channel environment, in a multi-carrier system, as many photoelectric converters as the number of carriers may be required (especially in a multi-carrier system utilizing multiple wide bands in accordance with the plans for the use of the THz band described above). Therefore, a frame structure for a multi-carrier system may be considered. The down-converted signal based on the photoelectric converter may be transmitted in a specific resource area (e.g., a specific frame). The frequency domain of the specific resource area may comprise a plurality of chunks. Each chunk may comprise at least one Component Carrier (CC).

The following symbols/acronyms/terms are used herein as follows.
Beamforming: A technique for focusing a signal from an antenna to a specific receiver
Beam alignment: A technique for aligning the direction of a transmitted laser power beam with the direction of a receiver
Line-of-Sight (LOS): A wave traveling in a straight line in the line of sight
Amplified Spontaneous Emission (ASE): During the amplification process in an optical amplifier, an excited electron transitions to the ground state and emits light. In this naturally occurring phenomenon, the phase of the emitted light is randomized.
Linear gain region: A region of input signal power where an amplifier exhibits constant amplification gain regardless of the power of the input signal
Gain saturation: The decrease in amplification gain when a high-power signal is input to an amplifier
In-band: The wavelength band that contains the signal transmitted by the transmitter
Out-of-band: A wavelength band outside the transmitter that does not contain the transmitted signal
Beating noise: Noise caused by the multiplication of light sources when different light sources are input to a photodetector
Stimulated emission: A process in which an excited electron transitions to the ground state under the stimulus of externally incident light, resulting in the emission of coherent light that is in phase with the externally incident light

In OWC, unlike RF communications in LTE or NR, when strong interference from outdoor daylight (i.e., sunlight) enters the receiver, the daylight interference may be very large relative to the target signal. Theoretically, the magnitude of daylight may be up to 0.26 W/m\hat{ }2/nm for a wavelength of 1550 nm.

In addition, in OWC, very small beamwidths are expected to be used, unlike RF communications in LTE or NR. In mobile OWC environments, unlike fixed OWC environments, LOS cannot always be guaranteed due to the mobility and rotatability of mobile devices, so reception over a Non-LOS (NLOS) path through a reflector may be required to avoid link failure due to obstacles. As a result, the probability of interference from daylight may be increased if multiple receive links are formed and used by the receiver to achieve diversity in the receive path.

If daylight irradiates the receiver photodiode, the receiver may be permanently damaged. To avoid damage, the Signal-to-Noise Ratio (SNR) of the target signal may be reduced by reducing the receiver sensitivity through an attenuator or optical filter.

To address these issues, a photoelectric amplification receiver based on a multi-aperture system may be utilized to construct an optical receiver that is robust to solar noise and link loss. The multi-aperture system increases the number of concentrators to increase the connectivity of the transmit and receive ends, and the final SNR may be maximized using a maximum ratio combining algorithm. A photoelectric amplification receiver with a built-in optical amplifier and optical attenuator may take advantage of the gain and gain saturation region of the optical amplifier to improve reception sensitivity, while still being able to operate reliably with high power solar noise input.

The maximum ratio combining algorithm is a multi-antenna (aperture) receiver algorithm that may achieve optimal SNR. In a multi-antenna receiver with N antennas, when the signal input to the i-th antenna is xᵢ (1≤i≤N) and the noise present in the signal is nᵢ (1≤i≤N), the constant wᵢ to be multiplied by each antenna may satisfy the following equation.

$$\begin{matrix}{w}_{i} = \frac{{x}_{i}}{{\overline{n}}_{i}^{2}} & ( 1 \leq i \leq N )\end{matrix} \qquad [ Equation 1 ]$$

Equation 1 above involves calculating the power of the noise components. If the same noise component is present for all antennas (e.g., thermal noise), wᵢ may simply be expressed as the ratio of the input signals between antennas, but an OWC receiver with varying noise components (ASE noise, solar noise) may require a separate noise estimator. Furthermore, the photoelectric amplification receiver needs to be designed to operate in the linear gain region of the optical amplifier when a transmitted optical signal is input, and in the gain saturation region when high power solar noise is input.

Based on the above-described scheme, the present disclosure describes a mobile wireless optical communication system receiver that satisfies the described requirements.

According to an implementation of the present disclosure, a receiver structure may be proposed that controls the effects of daylight while obtaining maximum ratio combining diversity for a plurality of receive paths in a receiver of a wireless optical communication system. The receiver of a wireless optical communication system, which may comprise a plurality of receive links according to an implementation of the present disclosure, may distinguish between a band of a target signal and a band other than the target signal, and detect daylight effects in the band other than the target signal. The detected daylight influence may be used as a weight to obtain a maximum ratio combining diversity. Thus, reception diversity may be adaptively acquired depending on whether daylight is incident or not. Furthermore, the receiver of a wireless optical communication system according to an implementation of the present disclosure may adaptively operate in the face of significant power differences between the target signal and daylight through the settings of the optical amplifier and the optical attenuator to prevent damage to the photodiode of the receiver.

Various implementations of the present disclosure are described below.

The following drawings are created to explain specific embodiments of the present disclosure. The names of the specific devices or the names of the specific signals/messages/fields shown in the drawings are provided by way of example, and thus the technical features of the present disclosure are not limited to the specific names used in the following drawings.

### 1. First Implementation: Single Photoelectric Amplification Receiver

A single photoelectric amplification receiver according to a first implementation of the present disclosure detects a baseband electrical signal (G₁) of an input optical signal and simultaneously monitors noise (G₂).

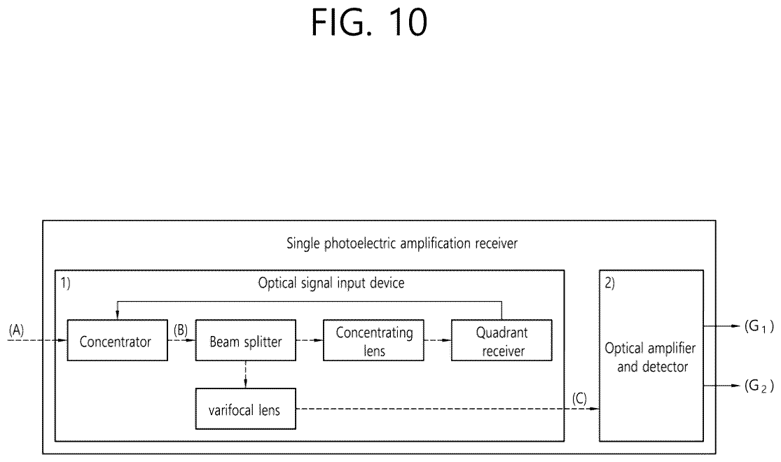

FIG. 10 shows an example of a structure of a single photoelectric amplification receiver according to the first implementation of the present disclosure.

Referring to FIG. 10, a single photoelectric amplification receiver according to the first implementation of the present disclosure includes 1) an optical signal input device, and 2) an optical amplifier and detector.

First, 1) the optical signal input device will be described.

The optical signal input device according to the first implementation of the present disclosure includes a light concentrator, a beam splitter, a light concentrating lens, a quadrant receiver, and a varifocal lens. The optical signal input device maximizes the power of a received optical signal. Each component of the optical signal input device plays the following roles.
The concentrator focuses the received optical signal parallel to the incident path of the beam splitter.
The beam splitter distributes the optical signal power equally between the concentrating lens and the varifocal lens.
The concentrating lens focuses the optical signal traveling from the beam splitter toward the quadrant receiver onto the receiving zones of the quadrant receiver.
The quadrant receiver passes receiver direction control information based on the electrical signals from each receiving area back to the concentrator via a feedback path.
A varifocal lens adjusts the focus of the optical signal input to the optical fiber of the optical amplification and detection device to ensure maximum power coupling.

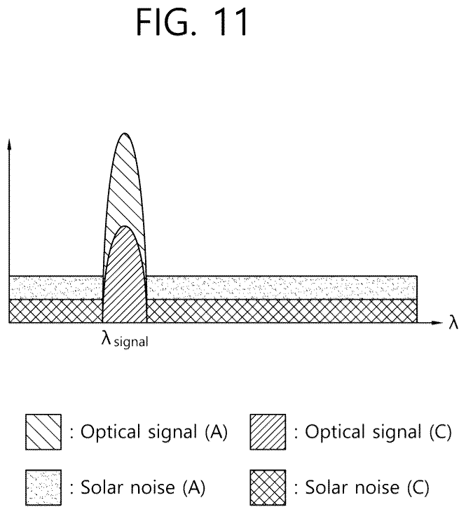

FIG. 11 shows an example of an input (A) of a single photoelectric amplification receiver and an input (C) of an optical amplification and detection device according to the first implementation of the present disclosure.

The input (A) of the optical signal input device may include either an optical signal or solar noise, and/or both an optical signal and solar noise. Referring to FIG. 11, by controlling the direction of the concentrator based on feedback information from the quadrant receiver, the output (B) of the concentrator of the optical signal input device may be ensured that the maximum possible power of the optical signal is input to the beam splitter. The output of the beam splitter is lowered by 3 dB compared to the input (B) of the beam splitter. As a result, considering the losses in the concentrator, beam splitter, and varifocal lens, the optical signal and/or solar noise (C) input to the optical amplifier and detector may be represented as shown in FIG. 11.

### 2) The Optical Amplifier and Detector Will be Described.

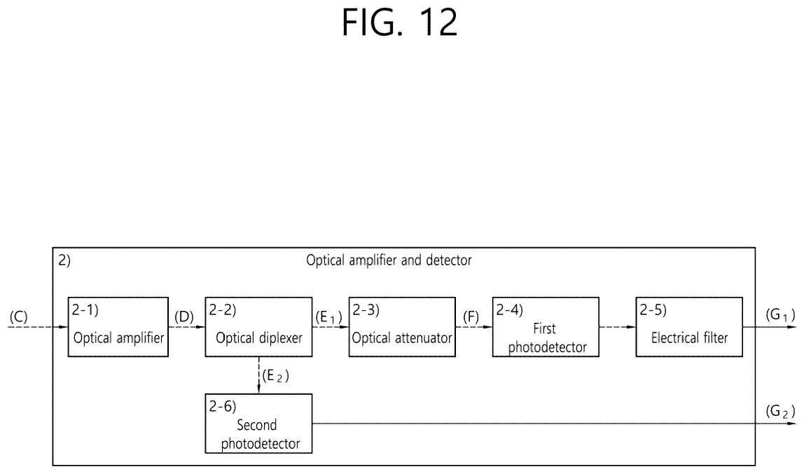

FIG. 12 shows an example of a structure of an optical amplifier and detector constituting a single photoelectric amplification receiver according to the first implementation of the present disclosure.

The optical amplifier and detector according to the first implementation of the present disclosure includes an optical amplifier, an optical diplexer, an optical attenuator, a first photodetector, an electrical filter, and a second photodetector. The optical amplifier and detector converts the optical signal (C) coupled from the varifocal lens of the optical signal input device described in FIG. 10 into a baseband electrical signal (G₁) capable of digital signal processing. Further, the solar noise present in the optical signal (C) and/or the ASE noise components added by the optical amplifier are monitored via the direct current electrical signal (G₂).

The procedure performed in the optical amplifier and detector according to the first implementation of the present disclosure is as follows.
The input optical signal (C) of the optical amplifier and detector is first amplified by the optical amplifier. At this time, the magnitude of the power of the input optical signal is P_{(C)}.
The optical diplexer filters the output (D) of the optical amplifier to an in-band wavelength band (i.e., λ_{signal}) in which the transmitted optical signal is present, and outputs it to the optical attenuator (E₁). The optical diplexer also filters the output (D) of the optical amplifier to an out-of-band wavelength band (i.e., λₙₒᵢₛₑ) in which the optical signal is not present, and outputs it to a second photodetector (E₂). The out-of-band wavelength band (i.e., λₙₒᵢₛₑ) may be defined by the optical diplexer as the band that excludes the in-band wavelength band (i.e., λ_{signal}) for the entire signal band that has passed through the optical amplifier.
The optical signal (E₁) in the in-band wavelength band after passing through the optical diplexer is converted to a baseband electrical signal in the first photodetector after passing through the optical attenuator, and finally filtered to match the transmitted optical signal bandwidth in the electrical filter to produce an output (G₁).
The solar and/or ASE noise (E₂) in the out-of-band wavelength band that has passed through the optical diplexer is converted to a DC electrical signal (G₂) at the second photodetector.

The noise N_{(G1)}) present in the baseband electrical signal (G₁) output by the above-described procedure is composed of thermal noise (N_{Th}) generated by the first photodetector, shot noise (Nₛₕₒₜ), solar noise input to the concentrator, and ASE noise generated by the optical amplifier, and signal-sunlight beating noise (N_{sig-sun}), signal-ASE beating noise (N_{sig-ASE}), sunlight-ASE beating noise (N_{sun-ASE}), sunlight-sunlight beating noise (Nₛᵤₙ₋ₛᵤₙ), and ASE-ASE beating noise (N_{ASE-ASE}) generated by beating the transmitted optical signal. Each noise may be calculated by Equation 2 below.

$$\begin{matrix}{\overline{N}}_{( {G}_{1} )}^{2} = {\overline{N}}_{Th}^{2} + {\overline{N}}_{shot}^{2} + {\overline{N}}_{sig - sun}^{2} + {\overline{N}}_{sig - ASE}^{2} + 2 {\overline{N}}_{sun - ASE}^{2} + 2 {\overline{N}}_{sun - sun}^{2} + 2 {\overline{N}}_{ASE - ASE}^{2} \\ {\overline{N}}_{Th}^{2} = \frac{4 {kTB}_{e}}{r} \\ {\overline{N}}_{shot}^{2} = \frac{2 {qR}_{1} {B}_{e}}{4} ( {GP}_{opt\_ ( c )} + 2 {GS}_{sun} {AB}_{o 1} + 2 {n}_{sp} ( G - 1 ) {hfB}_{o 1} ) \\ {\overline{N}}_{sig - sun}^{2} = 4 {( \frac{{R}_{1} G}{α} )}^{2} {P}_{opt\_ ( c )} {S}_{sun} {AB}_{e} \\ {\overline{N}}_{sig - ASE}^{2} = 4 {( \frac{{R}_{1}}{α} )}^{2} {GP}_{opt\_ ( c )} {n}_{sp} ( G - 1 ) {hfB}_{e} \\ {\overline{N}}_{sun - ASE}^{2} = 4 {( \frac{{R}_{1}}{α} )}^{2} {GS}_{sun} {An}_{sp} ( G - 1 ) {hfB}_{e} ( 2 {B}_{o 1} - {B}_{e} ) \\ {\overline{N}}_{sun - sun}^{2} = {( \frac{{R}_{1} {GS}_{sun} A}{α} )}^{2} {B}_{e} ( 2 {B}_{o 1} - {B}_{e} ) \\ {\overline{N}}_{ASE - ASE}^{2} = {( \frac{{R}_{1} {n}_{sp} ( G - 1 ) hf}{α} )}^{2} {B}_{e} ( 2 {B}_{o 1} - {B}_{e} )\end{matrix} \qquad [ Equation 2 ]$$

In Equation 2 above, k is the Boltzmann constant, T is the temperature, Bₑ is the bandwidth of the electrical filter, r is the resistance, q is the elementary charge of the electron, R1 is the reactivity of the first photodetector, a is the attenuation of the attenuator, and G is the gain of the optical amplifier, P_{opt_(C)} is the power of the received optical signal input to the optical amplifier and detector, Sₛᵤₙ is the irradiance of sunlight, A is the aperture width of the receiver, nₛₚ is the natural emission coefficient of the optical amplifier, h is Planck's constant, and Bₒ₁ is the in-band wavelength bandwidth of the optical diplexer. f_{signal} is the center frequency of the optical signal.

In Equation 2 above, the factor 2 applied to the sunlight-ASE beating noise (N_{sun-ASE}), sunlight-sunlight beating noise (Nₛᵤₙ₋ₛᵤₙ), and ASE-ASE beating noise (N_{ASE-ASE}) is the result of simultaneously considering the solar noise and ASE noise present in the vertical and horizontal polarizations.

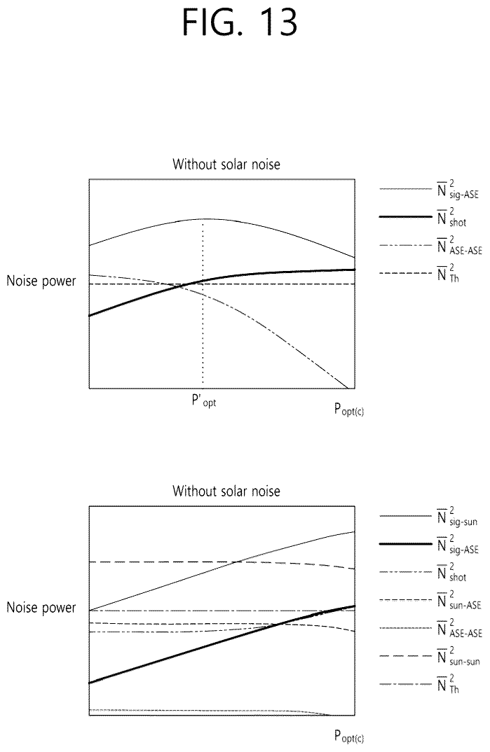

FIG. 13 shows an example of power distribution of components of an optical amplifier and detector output noise (N_{(G1)}) with and without solar noise, according to the first implementation of the present disclosure.

FIG. 13 shows power distribution of components of the optical amplifier and detector output noise (N_{(G1)}) with and without solar noise in the input (A) of the single photoelectric amplification receiver, with respect to the power P_{opt_(C)} of the optical signal received by the optical amplifier and detecor.

In FIG. 13, the tendency of the power of the components of the noise N_{(G1)} may be derived from the relationship between P_{opt_(C)} and G in Equation 2 above. G is characterized by decreasing with increasing P_{opt_(C)} due to the gain saturation phenomenon of the optical amplifier, which will be discussed later in 2-1).

Among the noise described in Equation 2 above:
The power of N_{Th} does not include P_{opt_(C)} and G and therefore has a constant value.
The power of N_{sig-sun}, N_{sig-ASE} is proportional to P_{opt_(C)}G². Therefore, the noise power tends to decrease in the range P′ₒₚₜ<P_{opt_(C)}, where the decrease in power due to G² is larger than the increase in power due to P_{opt_(C)}.
The power of Nₛᵤₙ₋ₛᵤₙ, N_{sun-ASE}, and N_{ASE-ASE} is proportional to G² only, so the decrease is the largest.
The power of Nₛₕₒₜ is proportional to G(P_{opt_(c)}+2SₛᵤₙAB_{O1}+2nₛₚhfB_{O1}), with a constant characteristic for P_{opt_(c)}<2SₛᵤₙAB_{O1}+2nₛₚhfB_{O1} and an increasing characteristic for P_{opt_(c)}≥2SₛᵤₙAB_{O1}+2nₛₚhfB_{O1}.

When only the optical signal received in (A) is present at the input (C) of the optical amplifier and detector, N_{sig-ASE} dominates, while N_{sig-sun} and Nₛᵤₙ₋ₛᵤₙ dominate when solar noise is also input. The dominant noise power in each situation may be an important factor for the determination of the signal-to-noise ratio and the determination of the receiver performance, in deciding the received signal based on the output (G₁) of the optical amplifier and detector.

The variables used for the power distribution of the components of the noise N_{(G1)} and the power P_{opt_(C)} of the received optical signal in FIG. 13 are shown in Table 5.

TABLE 5

| Parameter | Value | |
|---|---|---|
| T | 300 | k |
| k | 1.38 × 10⁻²³ | J/K |
| r | 50 | Ω |
| h | 6.63 × 10⁻³⁴ | m²kg/s |
| q | 1.6 × 10⁻¹⁹ | C |
| c | 3 × 10⁸ | m/s |
| λ | 1549.24 | nm |
| A | 3.98 × 10⁻⁴ | m² |
| R₁ | 0.64 | A/W |
| Bₐₘₚ | 4.38 | THz |
| Bₒ₁ | 100 | GHz |
| Bₑ | 33 | GHz |
| Sₛᵤₙ | 1.05 × 10⁻¹² | W/m2/Hz |

The components of the noise N_{(G1)} are described more specifically. In contrast to RF communication in LTE or NR, in OWC communication, in addition to thermal noise (N_{Th}), shot noise (Nₛₕₒₜ), which depends on the magnitude of the received signal, and beating noise generated by the beating of incoherent signals in the photodetector may be added. Sunlight is a non-coherent signal and may be assumed to be noise with the same characteristics as natural amplified emission noise. Since sunlight may be incident on a receiver with a light intensity that is very large relative to the expected size of the intended signal to be received, the beating noise attributed to sunlight may have a very large impact on the receiver.

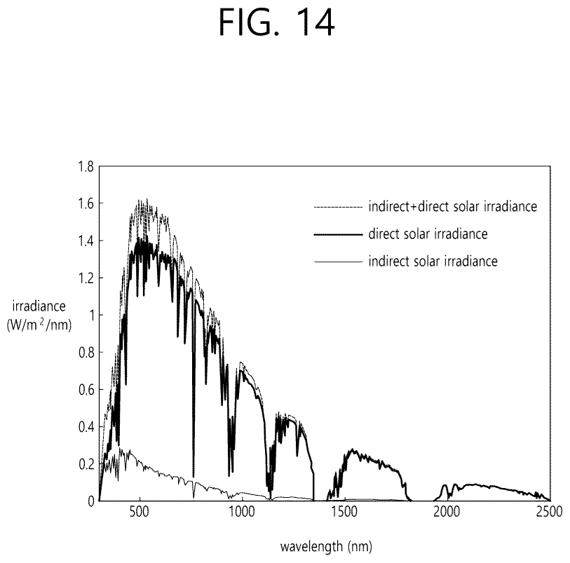

FIG. 14 shows an example of irradiance spectrum of sunlight.

In FIG. 14, direct solar irradiance refers to sunlight incident directly on the receiver from the sun at latitude 37°, and indirect solar irradiance refers to sunlight scattered and reflected by the rest of the atmosphere. Referring to FIG. 14, it can be seen that direct solar irradiance is relatively large in the entire irradiance spectrum, especially in the wavelength band above 1000 nm, where only the effect of direct solar irradiance needs to be considered.

For example, if the receiver has a Field-of-View (FoV) of 5.8°, analyzing the degradation of the receiver's sensitivity due to solar irradiance, the amount of solar irradiance incident on the receiver is shown in Table 6. It may be assumed that the radiance due to indirect solar irradiance has the same value for all solid angles.

TABLE 6

| | | |
|---|---|---|
| Wavelength | Direct Solar Irradiance | Indirect Solar Irradiance |

| | | | | | |
|---|---|---|---|---|---|
| 780 | nm | 1.0687 | W/m²/nm | 0.000244 | W/m²/nm |
| 1550 | nm | 0.2623 | W/m²/nm | 0.0000195 | W/m²/nm |

In other words, referring to Table 6, the interference for the 780 nm or 1550 nm wavelengths considered in mobile OWC systems may be expressed as the sum of direct solar irradiance and indirect solar irradiance. In this case, if the receiver is unable to recognize the reception of sunlight, the photodiode of the receiver may be damaged. Photodiodes are devices with nonlinear characteristics, and when they reach a saturation point, they become more and more nonlinear until they reach a damage threshold point, where they can no longer output a photocurrent when energy above the damage threshold is applied. Then, the excess energy cannot be absorbed by the photodiode and is converted to heat inside the device, which can damage the photodiode surface. Therefore, the interference of sunlight in mobile OWC systems hinders the operational stability of mobile OWC receivers, and a solution is needed to solve it.

Meanwhile, by Equation 2 above, the Power Spectral Density (PSD) of the output signal across the electrical filter in the frequency domain may be calculated.

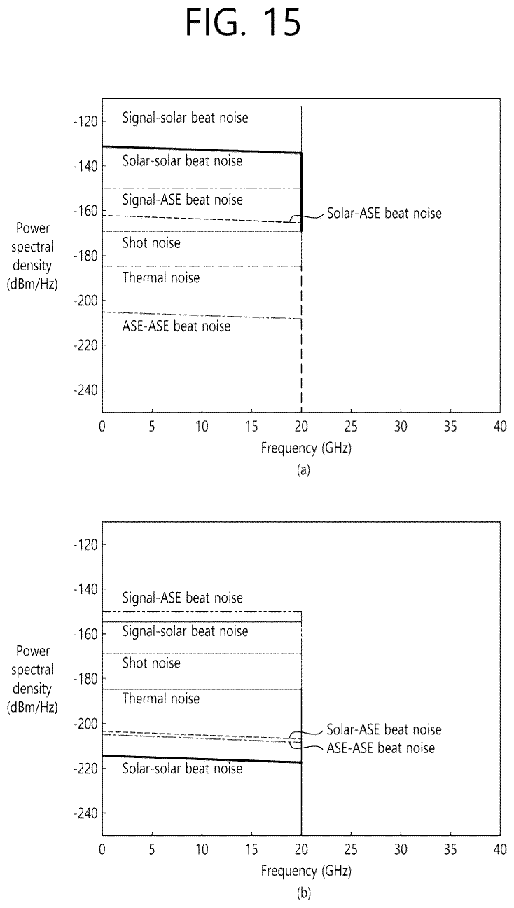

FIG. 15 shows an example of PSD of noise at the output of an electrical filter of a single photoelectric amplification receiver in the 1550 nm wavelength band as a function of the direct solar irradiance and indirect solar irradiance incident on the receiver.

Referring to FIG. 15, ASE noise generated by the photoelectric amplifier in a receiver operating in the 1550 nm wavelength band is shown, and various beating noises are added to the receiver output. It can be seen that the signal-to-sunlight beating noise, sunlight-to-sunlight beating noise, and sunlight-to-ASE beating noise have the largest PSDs.

FIG. 15-(a) shows the PSD under direct solar irradiance. In FIG. 15-(a), it can be seen that signal-sunlight beating noise and sunlight-sunlight beating noise have the largest PSDs of about −113 and −133 dBm, respectively, which are expected to directly affect the performance of the receiver. Other sunlight-ASE beating noise, ASE-ASE beating noise, shot noise, and thermal noise is expected to have a relatively small impact on the receiver's performance.

FIG. 15-(b) shows the PSD under indirect solar irradiance. In FIG. 15-(b), the signal-ASE beating noise, signal-sunlight beating noise, and shot noise have PSDs of about −150, −156, and −169 dBm, respectively.

This means that, similar to the Avalanche Photo Detector (APD) Intensity Modulation/Direct Detection (IM/DD) receiver, when direct solar irradiance is applied to the receiver, it is expected to generate a higher level of noise of 30 dB or more compared to indirect solar irradiance.

In summary, unlike RF communications in LTE or NR, in mobile OWC systems, the effects of daylight are very significant and can permanently damage the receiver. Accordingly, in accordance with implementations of the present disclosure, a method may be proposed for measuring the impact of daylight and setting a maximum ratio combining weight based on the measured impact of daylight to reduce the impact of beating noise generated by daylight and improve reception performance. Further, in accordance with implementations of the present disclosure, an optical amplifier and detector may be designed to prevent the receiver from being damaged by daylight.

Detailed components of the optical amplifier and detector according to the first implementation of the present disclosure described in FIG. 12 will be described.

### 2-1) Optical Amplifier

In the optical amplifier, amplification of an optical signal is achieved by induced emission of excited electrons in an optical path. If the amount of excited electrons is sufficient to maintain density inversion, the gain of the optical amplifier is constant with respect to the power of the input optical signal. If the power of the input optical signal continues to increase such that a significant proportion of the electrons excited by induced emission are exhausted relative to the increased number of signal photons in the optical path, a gain saturation phenomenon occurs in which the average density inversion decreases and the amplification gain of the optical amplifier decreases.

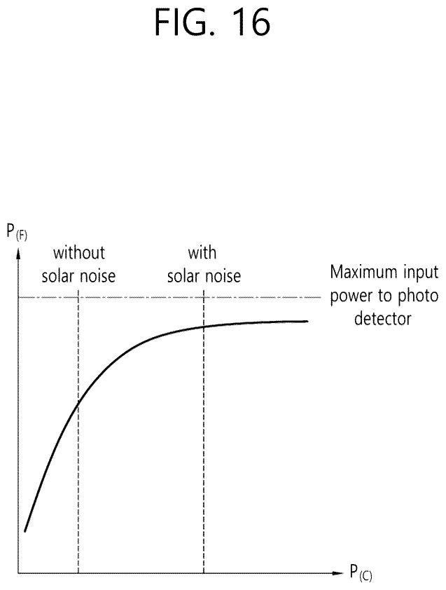

FIG. 16 shows an example of relationship of output power P_{(F)} as a function of input power P_{(C)} of an optical signal input to an optical amplifier.

Referring to FIG. 16, if the input signal (C) of the optical amplifier contains only optical signals (i.e., P_{(C)}=P_{opt_(C)}), then P_{(F)} increases linearly with an increase in P_{(C)} because the gain of the optical amplifier is constant. On the other hand, if the input signal (C) of the optical amplifier includes solar noise in addition to the optical signal (i.e., P_{(C)}=P_{opt_(C)}+P_{sun_(C)}), gain saturation occurs, which lowers the slope of P_{(F)}, i.e., the gain of the optical amplifier. Therefore, when high-power solar noise is included in the input signal (C) of the optical amplifier, this gain saturation characteristic of the optical amplifier may be utilized to provide low gain, thereby preventing receiver failure due to unexpected high-power solar noise.

### 2-2) Optical Diplexer

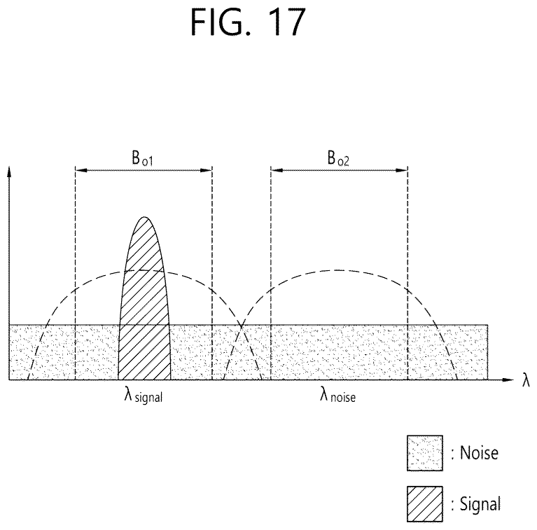

FIG. 17 shows an example in which an input optical signal is filtered by an optical diplexer according to the first implementation of the present disclosure.

Referring to FIG. 17, the optical diplexer filters the input optical signal (D) into an in-band wavelength band (center wavelength: λ_{signal}, bandwidth: B_{O1}) and an out-of-band wavelength band (center wavelength: λₙₒᵢₛₑ, bandwidth: B_{O2}). The filtered optical signal (E₁) in the in-band wavelength band is input to the optical attenuator, and the noise (E₂) in the out-of-band wavelength band is input to the second photodetector. At this time, λ_{signal} and λₙₒᵢₛₑ should be far enough apart so that the optical signal component received in B_{O2} is not included in the optical signal (E₁) in the in-band wavelength band.

### 2-3) Optical Attenuator

The optical attenuator may be designed considering the limit of the input optical power of the first photodetector.

The attenuation amount a of the optical attenuator may be calculated by Equation 3.

$$( {P}_{opt\_ ( c )} + \frac{{P}_{sun\_ ( c )} {B}_{o 1}}{{B}_{ump}} ) [ dBm ] + G [ dB ] - α [ dB ] < {P}_{PDlim} [ dBm ] \qquad [ Equation 3 ]$$

In Equation 3 above, P_{opt_(C)} is the power of the optical signal included in the input signal (C) of the optical amplifier, P_{sun_(C)} is the power of the solar noise that may be included in the input signal (C) of the optical amplifier, G is the gain of the optical amplifier corresponding to the power P_{opt_(C)}+P_{sun_(C)} of the input signal of the optical amplifier, Bₐₘₚ is the bandwidth of the optical amplifier, and P_{PDlim} is the input optical power limit of the first photodetector.

In other words, if the input signal (C) of the optical amplifier includes solar noise, the range of α that can protect the first photodetector may be calculated by Equation 3 above. Here, α is expressed in dB for simplicity of expression.

### 2-4) First Photodetector

The first photodetector converts the optical signal (F) input from the optical attenuator into a baseband electrical signal. The output terminal of the first photodetector is Alternating Current (AC) coupled to remove the DC component of the baseband electrical signal caused by solar noise and ASE noise.

### 2-5) Electrical Filter

The electrical filter lowpass filters the baseband electrical signal output from the first photodetector. In general, considering the amount of noise power reduced by low-pass filtering and the increased inter-symbol interference of the corresponding baseband electrical signal, the bandwidth of the electrical filter that provides optimal performance may be set to about 70% of the signal bandwidth.

### 2-6) Second Photodetector

The second photodetector outputs the average power of the solar noise and ASE noise as a direct current. Therefore, the output terminal of the second photodetector should be capable of carrying the direct current component through a Direct Current (DC) couple.

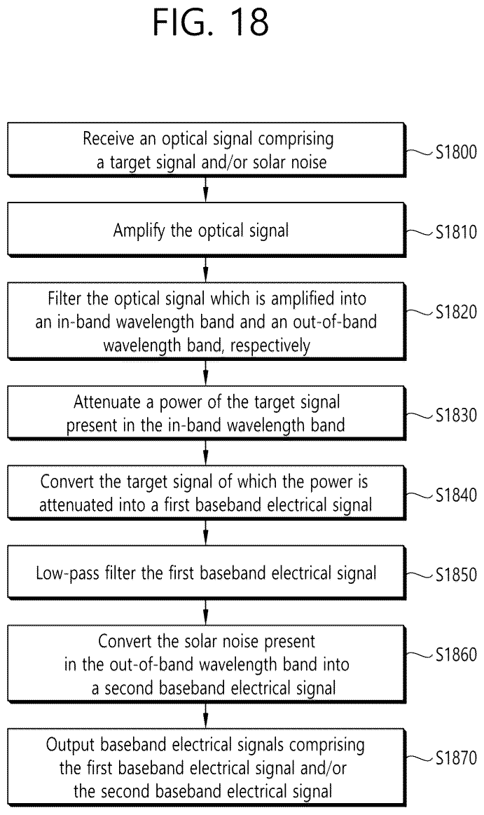

FIG. 18 shows an example of a method performed by a receiver operating in an OWC system according to the first implementation of the present disclosure.

The receiver operating in the OWC system of FIG. 18 may be a single photoelectric amplification receiver according to the first implementation of the present disclosure described in FIGS. 10 through 17. That is, the description of the single photoelectric amplification receiver according to the first implementation of the present disclosure described in FIGS. 10 through 17 may apply to the method of FIG. 18.

In step S1800, the method comprises receiving an optical signal comprising a target signal and/or solar noise. Step S1800 may be performed by the optical signal input device described in FIG. 10.

In step S1810, the method comprises amplifying the optical signal. Step S1810 may be performed by the optical amplifier described in FIG. 12.

In step S1820, the method comprises filtering the optical signal which is amplified into an in-band wavelength band and an out-of-band wavelength band, respectively. Step S1820 may be performed by the optical diplexer described in FIG. 12.

In step S1830, the method comprises attenuating a power of the target signal present in the in-band wavelength band. Step S1830 may be performed by the optical attenuator described in FIG. 12.

In step S1840, the method comprises converting the target signal of which the power is attenuated into a first baseband electrical signal. Step S1840 may be performed by the first photodetector described in FIG. 12.

In step S1850, the method comprises low-pass filtering the first baseband electrical signal. Step S1850 may be performed by the electrical filter described in FIG. 12.

In step S1860, the method comprises converting the solar noise present in the out-of-band wavelength band into a second baseband electrical signal. Step S1860 may be performed by the second photodetector described in FIG. 12.

In step S1870, the method comprises outputting baseband electrical signals comprising the first baseband electrical signal and/or the second baseband electrical signal.

In some implementations, the out-of-band wavelength band may not include the target signal.

In some implementations, the optical attenuator may be designed based on an input optical power threshold of the first photodetector.

In some implementations, an output terminal of the first photodetector may be AC coupled.

In some implementations, an output terminal of the second photodetector may be DC coupled.

In some implementations, the optical amplifier may have a gain saturation characteristic.

The single photoelectric amplification receiver according to the first implementation of the present disclosure described through FIGS. 10 through 18, may correspond to the transceiver 106 included in the first wireless device 100 shown in FIG. 2. Alternatively, the single photoelectric amplification receiver according to the first implementation of the present disclosure described through FIGS. 10 through 18, may correspond to the communication device 110 and/or the transceiver 114 included in the wireless device 100 shown in FIG. 3. Alternatively, the single photoelectric amplification receiver according to the first implementation of the present disclosure described through FIGS. 10 through 18, may correspond to the transceiver 106 included in the UE 100 shown in FIG. 4.

According to the first implementation of the present disclosure, receiver failure due to solar noise, which is inevitable in mobile OWC systems, can be avoided. Furthermore, by using an optical amplifier, the reception sensitivity of the OWC receiver can be significantly improved.

### 2. Second Implementation: Multiple Aperture-Based Mobile OWC Receiver

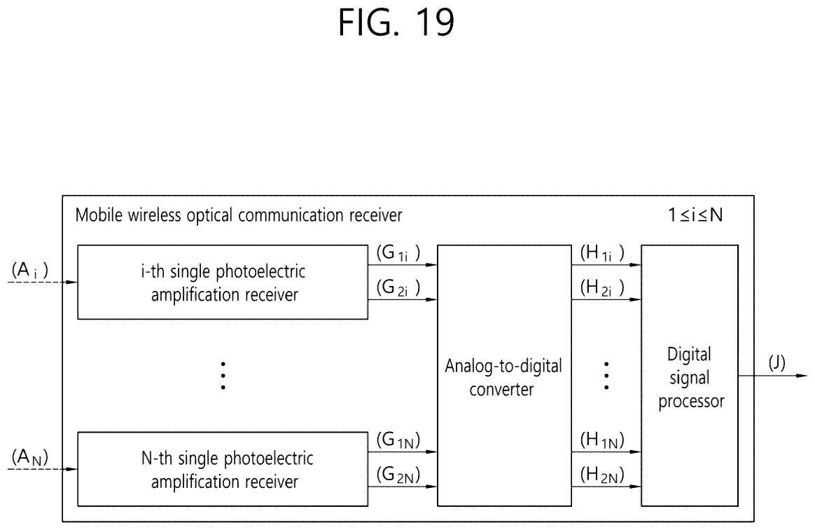

FIG. 19 shows an example of a structure of a multiple aperture-based mobile OWC receiver according to the second implementation of the present disclosure.

Referring to FIG. 19, the multiple aperture-based mobile OWC receiver includes 1) at least one single photoelectric amplification receiver according to the first implementation of the present disclosure, 2) an analog-to-digital converter, and 3) digital signal processor.

According to the second implementation of the present disclosure, a procedure performed in the multiple aperture-based mobile OWC receiver is as follows.
The at least one single photoelectric amplification receiver outputs baseband electrical signals, G₁ and G₂, for the target signal and solar noise, respectively. For example, the outputs of the i-th single photoelectric amplification receiver may be G₁ᵢ, G₂ᵢ, and the outputs of the N-th single photoelectric amplification receiver may be G_{1N}, G_{2N}.
The outputs G₁ᵢ and G₂ᵢ of the baseband electrical signals of each single photoelectric amplification receiver are input to the analog-to-digital converter and sampled. At this time, the sampling frequency fₛ of the analog-to-digital converter should be at least twice the bandwidth of G₁ᵢ to avoid aliasing. The outputs G₁ᵢ and G₂ᵢ of the baseband electrical signals of each input single photoelectric amplification receiver are sampled by the analog-to-digital converter and output as discrete signals H₁ᵢ and H₂ᵢ.
The outputs H₁ᵢ and H₂ᵢ of the analog-to-digital converter are input to the digital signal processor and used to calculate the maximum ratio combining algorithm. At this time, the weight wᵢ of the maximum ratio combining that is multiplied by H₁ᵢ may be calculated by Equation 4.

$${w}_{i} = \frac{\sqrt{E [ {H}_{1 i}^{2} ]}}{\frac{2 {R}_{1}}{α} \{ \frac{+ \sqrt{E [ {H}_{1 i}^{2} ]} E [ {H}_{2 i} ] {B}_{e 1}}{{R}_{2} {B}_{o 2}} + \frac{{R}_{1}}{α} {( \frac{E [ {H}_{2 i} ]}{{R}_{2} {B}_{o 2}} )}^{2} {B}_{e 1} ( 2 {B}_{o 1} - {B}_{e 1} ) \}} ( 1 \leq i \leq N ) \qquad [ Equation 4 ]$$

Equation 4 is the result of calculating the Equation 1 using electrical signals detected according to implementations of the present disclosure. In Equation 4, H₁ᵢ and H₂ᵢ are the outputs of the analog-to-digital converter, B_{O1} and B_{O2} are the bandwidths of the optical diplexer, R1 and R2 are the responsivity of the first and second photodetectors, G is the gain of the optical amplifier, a is the attenuation amount of the attenuator, and Bₑ₁ is the bandwidth of the electrical filter.

The signal component corresponding to the numerator in Equation 1 above may be determined by calculating Equation 5, which is the Root Mean Square (RMS) average value of the optical signal input of the in-band of the maximum ratio combining algorithm calculation.

$$\sqrt{E [ {H}_{1 i}^{2} ]} \qquad [ Equation 5 ]$$

The noise component corresponding to the denominator in Equation 1 above may be determined by considering the dominant noise components N_{sig-ASE}, N_{sig-sun}, Nₛᵤₙ₋ₛᵤₙ, and additionally N_{ASE-ASE}. N_{ASE-ASE} is not the dominant noise, but serves to bring consistency to the noise calculation. N_{sig-ASE} is required to be included in the noise calculation if the input signal contains only optical signals, and N_{sig-sun} and Nₛᵤₙ₋ₛᵤₙ is required to be included in the noise calculation if the input signal contains optical signals and solar noise.

By approximating G≈G−1 in Equation 2, N_{sig-sun} and N_{sig-ASE} and Nₛᵤₙ₋ₛᵤₙ and N_{ASE-ASE} may have the same form except for the SₛᵤₙA and nₛₚhf terms, respectively. Furthermore, SₛᵤₙA and nₛₚhf may be estimated based on the average E[H₂ᵢ] of the out-of-band band signal power.

Therefore, from the components in the denominator of Equation 4, the part corresponding to Equation 6 may be summarized by the calculation of N_{ASE-ASE} and Nₛᵤₙ₋ₛᵤₙ.

$$2 {( \frac{{R}_{1} E [ {B}_{2 i} ]}{a {R}_{2} {B}_{o 2}} )}^{2} {B}_{e 1} ( 2 {B}_{o 1} - {B}_{e 1} ) \qquad [ Equation 6 ]$$

In addition, from the components in the denominator of Equation 4, the part corresponding to Equation 7 may be summarized by the calculation of N_{sig-ASE} and N_{sig-sun}.

$$\frac{{BR}_{1} \sqrt{E [ {H}_{1 i}^{2} ]} E [ {H}_{2 i} ] {B}_{e 1}}{{aR}_{2} {B}_{o 2}} \qquad [ Equation 7 ]$$

As a result, the weight wᵢ of the maximum ratio combining may be calculated using the same Equation 4 for both the case where the input signal contains only optical signals and the case where it also contains solar noise.

Finally, based on the output (I) from the maximum ratio combining algorithm calculation, digital clock restoration, synchronization, and hard judgment calculations are performed in the demodulator, and demodulation is performed with the final received data (J).

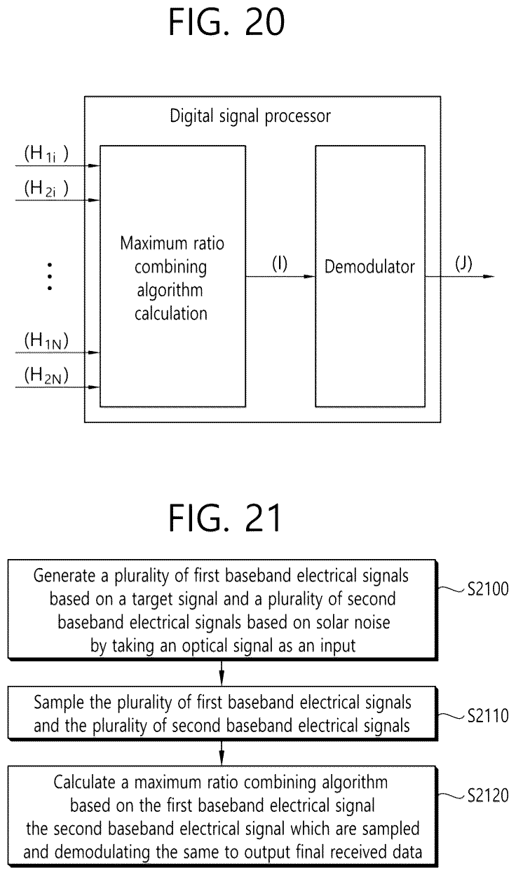

FIG. 20 shows an example of a structure of a digital signal processor included in a multiple aperture-based mobile OWC receiver according to the second implementation of the present disclosure.

FIG. 21 shows an example of a method performed by a receiver operating in an OWC system according to the second implementation of the present disclosure.

The receiver operating in the OWC system of FIG. 21 may be a multiple aperture-based mobile OWC receiver according to the second implementation of the present disclosure described in FIGS. 19 through 20. That is, the description of the multiple aperture-based mobile OWC receiver according to the second implementation of the present disclosure described in FIGS. 19 through 20 may be applicable to the method of FIG. 21.

In step S2100, the method comprises generating a plurality of first baseband electrical signals based on a target signal and a plurality of second baseband electrical signals based on solar noise by taking an optical signal as an input. Step S2100 may be performed by each single photoelectric amplification receiver described in FIG. 19.

In step S2110, the method comprises sampling the plurality of first baseband electrical signals and the plurality of second baseband electrical signals. Step S2110 may be performed by the analog-to-digital converter described in FIG. 19.

In step S2120, the method comprises calculating a maximum ratio combining algorithm based on the first baseband electrical signal the second baseband electrical signal which are sampled and demodulating the same to output final received data. Step S2120 may be performed by the digital signal processor described in FIG. 19.

In some implementations, the weight wᵢ of the maximum ratio combining for the maximum ratio combining algorithm may be calculated according to Equation 4 above.

In some implementations, in calculating a noise component in the weight wi of the maximum ratio combining (i.e., in calculating the denominator in Equation 4), signal-ASE beating noise, signal-sunlight beating noise, sunlight-sunlight beating noise, and ASE-ASE beating noise may be considered.

The multiple aperture-based mobile OWC receiver according to the second implementation of the present disclosure described in FIG. 19 through 21, may correspond to the processor 102 and/or the transceiver 106 included in the first wireless device 100 shown in FIG. 2. For example, the at least one single photoelectric amplification receiver included in the multiple aperture-based mobile OWC receiver according to the second implementation of the present disclosure may correspond to the transceiver 106 included in the first wireless device 100 shown in FIG. 2. Further, the analog-to-digital converter and the digital signal processor included in the multiple aperture-based mobile OWC receiver according to the second implementation of the present disclosure may correspond to the processor 102 included in the first wireless device 100 shown in FIG. 2.

Alternatively, the multiple aperture-based mobile OWC receiver according to the second implementation of the present disclosure described in FIG. 19 through 21, may correspond to the control unit 120 and/or the communication unit 110 and/or the transceiver 114 included in the wireless device 100 shown in FIG. 3. For example, the at least one single photoelectric amplification receiver included in the multiple aperture-based mobile OWC receiver according to the second implementation of the present disclosure may correspond to the communication device 110 and/or the transceiver 114 included in the wireless device 100 shown in FIG. 3. Further, the analog-to-digital converter and the digital signal processor included in the multiple aperture-based mobile OWC receiver according to the second implementation of the present disclosure may correspond to the control unit 120 included in the first wireless device 100 shown in FIG. 3.

Alternatively, the multiple aperture-based mobile OWC receiver according to the second implementation of the present disclosure described in FIG. 19 through 21, may correspond to the processor 102 and/or the transceiver 106 included in the UE 100 shown in FIG. 4. For example, the at least one single photoelectric amplification receiver included in the multiple aperture-based mobile OWC receiver according to the second implementation of the present disclosure may correspond to the transceiver 106 included in the UE 100 shown in FIG. 4. Further, the analog-to-digital converter and the digital signal processor included in the multiple aperture-based mobile OWC receiver according to the second implementation of the present disclosure may correspond to the processor 102 included in the UE 100 shown in FIG. 4.

According to the second implementation of the present disclosure, it can be prevented that the SNR is reduced by external noise. Furthermore, by configuring the receiver to have multiple apertures overlapping the beamwidth of the incident optical signal, SNR gains can be achieved. The present disclosure is applicable to mobile OWC systems that utilize reflected waves.

The present disclosure can have various advantageous effects.

For example, based on a mobile OWC receiver comprising a plurality of Optical Frequency (OF) chains, reception diversity over a LOS/NLOS path can be obtained.

For example, in an environment where daylight interference may increase as reception diversity increases, daylight effects can be detected and maximum ratio combining diversity gain can be adaptively obtained.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A receiver operating in an Optical Wireless Communication (OWC) system, the receiver comprising:
an optical amplifier and detector that takes as input an optical signal comprising a target signal and/or solar noise and outputs baseband electrical signals for a digital signal processing process,
wherein the optical amplifier and detector comprises:
1) an optical amplifier that amplifies the optical signal to output an amplified optical signal;
2) an optical diplexer for filtering and outputting the amplified optical signal into an in-band wavelength band and an out-of-band wavelength band, respectively;
3) an optical attenuator that takes as input the target signal present in the in-band wavelength band and outputs an attenuated target signal with reduced power;
4) a first photodetector for converting the attenuated target signal into a first baseband electrical signal of the baseband electrical signals;
5) an electrical filter for low-pass filtering the first baseband electrical signal; and
6) a second photodetector for converting the solar noise present in the out-of-band wavelength band into a second baseband electrical signal of the baseband electrical signals.

2. The receiver of claim 1, wherein the out-of-band wavelength band does not include the target signal.

3. The receiver of claim 1, wherein the optical attenuator is designed based on an input optical power threshold of the first photodetector.

4. The receiver of claim 1, wherein an output terminal of the first photodetector is Alternating Current (AC) coupled.

5. The receiver of claim 1, wherein an output terminal of the second photodetector is Direct Current (DC) coupled.

6. The receiver of claim 1, wherein the optical amplifier has a gain saturation characteristic.

7. The receiver of claim 1, wherein the receiver further comprises an optical signal input device, and
wherein the optical signal input device comprises 1) a concentrator, 2) a beam splitter, 3) a concentrating lens, 4) a quadrant receiver, and 5) a varifocal lens.

8. A method performed by a receiver operating in an Optical Wireless Communication (OWC) system, the method comprising:
receiving an optical signal comprising a target signal and/or solar noise;
amplifying the optical signal;
filtering the optical signal which is amplified into an in-band wavelength band and an out-of-band wavelength band, respectively;
attenuating a power of the target signal present in the in-band wavelength band;
converting the target signal of which the power is attenuated into a first baseband electrical signal;
low-pass filtering the first baseband electrical signal;
converting the solar noise present in the out-of-band wavelength band into a second baseband electrical signal; and
outputting baseband electrical signals comprising the first baseband electrical signal and/or the second baseband electrical signal.

9. The method of claim 8, wherein the out-of-band wavelength band does not include the target signal.

10. A receiver operating in an Optical Wireless Communication (OWC) system, the receiver comprising:
a plurality of photoelectric amplification receivers each taking an optical signal as an input and outputting a first baseband electrical signal based on a target signal and a second baseband electrical signal based on solar noise;
an analog-to-digital converter for sampling the first baseband electrical signal and the second baseband electrical signal; and
a digital signal processor for calculating a maximum ratio combining algorithm based on the first baseband electrical signal the second baseband electrical signal which are sampled, and demodulating the same to output final received data.

11. The receiver of claim 10, wherein a weight wi of a maximum ratio combining for the maximum ratio combining algorithm is calculated according to an equation:
$${w}_{i} = \frac{\sqrt{E [ {H}_{1 i}^{2} ]}}{\frac{2 {R}_{1}}{α} \{ \frac{+ \sqrt{E [ {H}_{1 i}^{2} ]} E [ {H}_{2 i} ] {B}_{e 1}}{{R}_{2} {B}_{o 2}} + \frac{{R}_{1}}{α} {( \frac{E [ {H}_{2 i} ]}{{R}_{2} {B}_{o 2}} )}^{2} {B}_{e 1} ( 2 {B}_{o 1} - {B}_{e 1} ) \}} ( 1 \leq i \leq N )$$
where H₁ᵢ and H₂ᵢ represent outputs of the analog-to-digital converter, B_{O1} and B_{O2} represent bandwidths of an optical diplexer included in the photoelectric amplification receivers, R1 and R2 represent responsivities of first and second photodetectors included in the photoelectric amplification receivers, G represents a gain of an optical amplifier included in the photoelectric amplification receivers, a represents an attenuation amount of an attenuator included in the photoelectric amplification receivers, and Bel represents a bandwidth of an electrical filter included in the photoelectric amplification receivers.

12. The receiver of claim 11, wherein, in calculating a noise component in the weight wi of the maximum ratio combining, signal-Amplified Spontaneous Emission (ASE) beating noise, signal-solar beating noise, solar-solar beating noise, and ASE-ASE beating noise are considered.

13-15. (canceled)
